(19) United States
(12) Patent Application Publication
(10) Pub. No.: US 2005/0159326 A1
(43) Pub. Date: Jul. 21, 2005

(54) Method for cleaning carpet and other surfaces

(76) Inventor: Paul K. Hollingsworth, Henderson, NV (US)

Correspondence Address: STETINA BRUNDA GARRED & BRUCKER, 75 ENTERPRISE, SUITE 250, ALISO VIEJO, CA, 92656, US

(21) Appl. No.: 11/070,596

(22) Filed: Mar. 2, 2005

Related U.S. Application Data
(63) Continuation-in-part of application No. 10/067,474, filed on Feb. 4, 2002, now Pat. No. 6,865,762.

(51) Int. Cl. C11D 1/00

(52) U.S. Cl. 510/278

(57) ABSTRACT

A method for cleaning a soiled product by using a microwave heated cleaning composition. The method includes providing a hand-holdable single vessel with a hand-operable dispenser and an aqueous non-effervescent cleaning composition within the vessel. The vessel bearing the cleaning composition is placed into a microwave oven, and the cleaning composition is heated for a specified time period to a temperature of about 90-220 degrees F., whereupon a quantity of the cleaning composition is dispensed via the dispenser onto the soiled area. Finally, the treated area is blotted by hand with a fibrous towel or scraped, wiped, scrubbed, sponged or vacuumed for removal of cleaning composition and soil.

### CROSS-REFERENCE TO RELATED APPLICATIONS

This application is a continuation-in-part of application Ser. No. 10/067,474, filed Feb. 4, 2002.

### STATEMENT RE: FEDERALLY SPONSORED RESEARCH/DEVELOPMENT

Not Applicable

### BACKGROUND OF THE INVENTION

The present invention is related in general to a method of cleaning a product, and in particular to a method for cleaning a soiled surface with a previously microwave heated cleaning composition.

Scientists, home economists, and others are constantly striving for more effective cleaning products and methods to help the consumer save time and energy while cleaning. In addition to being effective, the cleaning products and methods must not be substantially harmful to the consumer.

The cleaning of carpet, upholstery, and other fabrics and/or surfaces is often troublesome and consumers must often resort to professional cleanings. Professional cleanings, however, must be scheduled, can become quite expensive, and are inconvenient. Moreover, it is well known that the likelihood of sufficiently removing a spot will substantially increase if promptly treated. Practically speaking, professional cleanings are therefore not available on a daily basis for everyday spills and spots.

In recognition of these problems, there have been several cleaning products developed for the consumer to clean carpet, upholstery, other fabrics and hard surfaces. Certain of these products as well as others have been especially developed for spot cleaning. Unfortunately, these products can often exacerbate a stain, particularly if they leave an invisible soapy film that dirt and dust later cling to. Furthermore, some of these products are just not effective against stubborn stains. For example, pet stains are notoriously resistant to treatment.

Generally speaking, when cleaning a carpet, textile fabric or a hard surface product, there are four factors which are used either alone or in conjunction with one another to achieve desired cleaning results. One factor is the use of a chemical composition. Another factor is dwell time, i.e., the time a chemical composition is allowed to reside on the carpet to treat the soiled area of the carpet, textile fabric or product. Agitation, such as the action of blotting or scrubbing, is a third factor. The fourth and often overlooked factor is heat. In this regard, a cleaning composition typically is more effective in cleaning soiled carpets, textiles and hard surfaces if the cleaning composition is elevated in temperature. To date, heat has been the primary cleaning factor that has been overlooked and missing from carpet, textile and hard surface cleaners available to consumers.

Accordingly, there is a need for a novel cleaning chemical composition for general and spot cleaning having improved effectiveness and a unique method for applying the same which can easily, safely, and effectively be used by a consumer for cleaning carpet, upholstery, fabric and other surfaces. Such a cleaning chemical composition and method are needed which can be used on substantially any spot or stain, including pet stains. Further, such a cleaning chemical composition and method are needed which do not leave a soapy residue to exacerbate the spot or stain. The present invention fulfills these needs and provides other related advantages.

### BRIEF SUMMARY OF THE INVENTION

The present invention comprises an apparatus and method for cleaning a soiled area of a surface such as a textile product (e.g., carpet) or a hard surface product (e.g., kitchen counter-top), and first includes the provision of a hand-holdable single vessel with a hand-operable dispenser for dispensing a liquid from within the vessel. Next, an aqueous non-effervescent cleaning composition comprising a ratio of a quantity of at least one cleaning chemical to a quantity of water of from about 1/16 to 8 cups cleaning composition to five gallons of water is prepared and placed within the vessel. Third, the vessel with the cleaning composition therein is placed into a microwave oven and heated to a temperature of between about 90 degrees F. and about 220 degrees F., whereupon the vessel is removed from the microwave oven and a quantity of the aqueous non-effervescent cleaning composition therein is substantially immediately applied by hand using the vessel dispenser on the soiled area to be cleaned. Finally, the soiled area so treated is blotted, scraped, wiped, scrubbed, and/or sponged by hand with a fibrous towel, sponge or the like or by machine such as with a vacuum for removal of cleaning composition and soil from the soiled area.

Preferably, the at least one cleaning chemical is sodium tripolyphosphate, however other chemical cleaners are contemplated herein. With respect to the vessel, it preferably has a height dimension of about six inches such that it is easily hand-holdable and that it readily fits in an upright orientation within a typical residential microwave oven compartment. The hand-operable dispenser preferably is a spray apparatus leading from an opening or spout of the vessel, thereby permitting the cleaning composition to be easily applied by hand operation of the spray apparatus for directed application to the soiled textile area. However, the dispenser may also be a pump, dauber or the like.

To finish cleaning the product, the soiled area treated with the heated cleaner may be vacuumed with a wet/dry vacuum.

### BRIEF DESCRIPTION OF THE DRAWINGS

An illustrative and presently preferred embodiment of the invention is shown in the accompanying drawings in which:

FIG. 1 is an exploded perspective view of a vessel containing a cleaning composition with the sprayer dispenser removed wherein the vessel has plural time graduations on the left side of the vessel corresponding to the fluid amount graduations indicated on the right side of the vessel; and

FIG. 2 is a perspective view of an open microwave oven within which the vessel of FIG. 1 is placed with the sprayer dispenser removed.

### DETAILED DESCRIPTION OF THE INVENTION

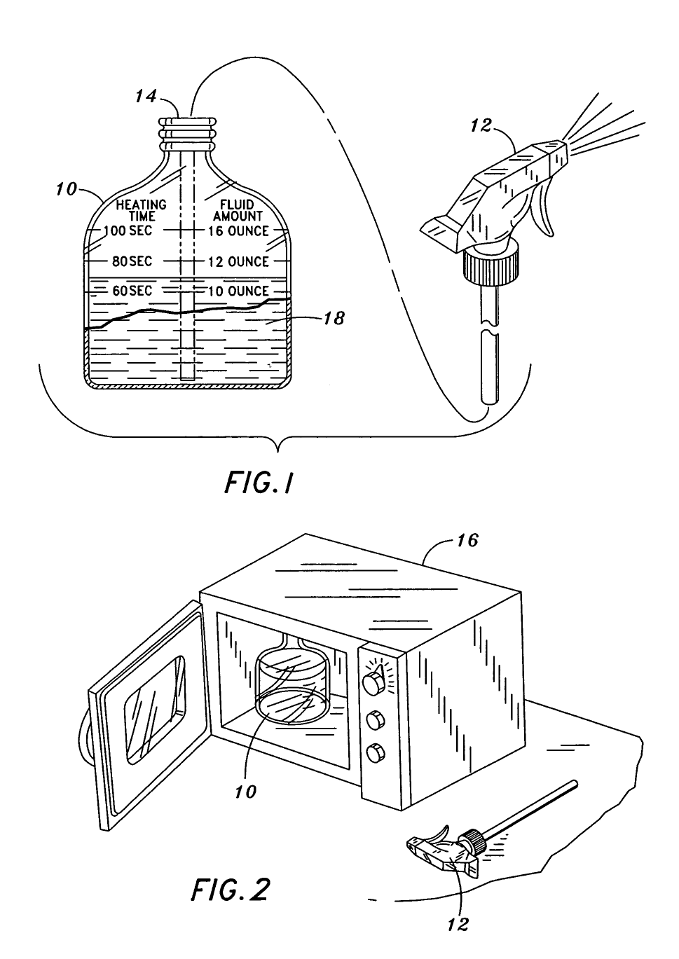

Referring to FIGS. 1 and 2, a vessel 10, hereby exemplified as a transparent graduated container having plural numeral designations of “10-,” “12-,” and “16-ounce” printed graduations thereon, as well as corresponding microwave heating time graduations such as 60, 80 and 100 seconds printed thereon, which heating times are commensurate with the particular cleaning composition and volume to raise the temperature of the solution volume to desired application ranges. The container 10 is shown in exploded form to demonstrate the screw top attachment of a hand-operable dispenser 12, here exemplified as a conventional trigger-spray apparatus, at a top opening 14 of the vessel 10. By way of example and not limitation, the dispenser may be a pump, dauber or the like. The vessel 10 and dispenser 12 typically are constructed of a plastic capable of withstanding at least about 220 degrees F. without deformation, and the vessel 10 is about six inches tall to thereby assure upright placement within the compartment of a conventional residential microwave oven 16 as shown in FIG. 2.

Within the vessel 10 is an aqueous non-effervescent cleaning composition 18 comprising a ratio of a quantity of at least one cleaning chemical to a quantity of water preferably from about 1/16 cup to about 8 cups cleaning chemical to about five gallons of water. While more than one cleaning chemical or fragrance can be incorporated into the cleaning composition so long as all cleaning chemicals are compatible, the preferable and sole cleaning chemical is sodium tripolyphosphate.

To accomplish the cleaning of a soiled area of a textile product such as carpet or upholstery or a hard surface product such as a kitchen counter top, a user places the composition-bearing vessel 10 (optionally, without the dispenser 12 in place) in the microwave oven 16 and heats the composition 18 to a temperature between about 90 and about 160 degrees F., a temperature at which the composition 18 (as well as the vessel 10) feels warm to the touch. Alternatively, the composition may be heated to a temperature between about 160 degrees F. and about 220 degrees F. The particular microwave heating time is easily facilitated by the plural time graduations formed on the vessel 10. Thereafter, the vessel is removed from the microwave oven 16, the dispenser 12 is attached, and a quantity of the aqueous non-effervescent cleaning composition 18 is substantially immediately applied by hand through the dispenser 12 onto the soiled area of the product (not shown) to be cleaned. Finally, the soiled area so treated is blotted by hand with a standard fibrous towel (not shown) for removal of composition and soil from the product. Additionally and alternatively, the soiled area so treated may be scraped, wiped, scrubbed, sponged or the like with a scraper, sponge or towel or vacuumed with a wet/dry vacuum.

In using the cleaning composition on upholstery or textiles, a manufacturer's cleanability code tag should first be consulted if possible. If the fabric is coded “WS” or “W”, use is appropriate. If the fabric is coded “X” or “S” or is velvet, silk, or leather, use is inappropriate. One must also consider that some fabrics require the use of foam or dry cleaning products. If suitable for the particular carpet, upholstery, or fabric, a hidden area should then be tested for colorfastness by conventional methods. If the color is not affected, the cleaning composition may be used. If the spot is dry, the spot should first be vacuumed to remove excess debris. The cleaning composition may then be applied to the spot, preferably by spraying. A clean, white terry cloth towel should then be used to wipe up the spot. Spraying and wiping may be repeated as needed. When cleaning a spot from upholstery, the towel should first be spray-dampened with the cleaning compound and then the damp towel can be used to gently rub the spot out of the upholstery.

If the stain remains resistant, a conventional enzyme cleaner may also be used on the spot. It is not necessary that the previous cleaning composition be dry on the carpet/fabric before using the enzyme cleaner. The enzyme cleaner should remain (i.e., dwell time) on the spot for up to about five minutes to allow the enzymes to break down soils and digest any proteins. The enzyme cleaner should then be wiped up with a clean, white terry cloth towel. After the enzyme cleaner has dried on the soiled area of the textile (usually by the next day), the soiled area should be rinsed again with clean water, the cleaning composition applied, and the treated area wiped up again. This treatment should substantially remove or lessen the spot or stain; however, some stains or soiling will cause permanent discoloration even after cleaning. To finish the cleaning process, the soiled area, treated with the heated cleaner may be vacuumed with a wet/dry vacuum to remove the soil from the treated area.

In preparing the cleaning composition, the microwave should not be left unattended. The cleaning composition should be left in the microwave until the vessel 10 can be handled safely. Children should not use the composition without adult supervision. The composition should not be mixed with bleach, or used with any incompatible product that could harm the product being cleaned.

As is apparent, the methodology here defined permits a user to effectively clean a soiled textile product by providing a heated, and therefore, more effective, cleaning composition and cleaning-composition application while accomplishing such maintenance with a hand-holdable single vessel and an aqueous, non-effervescent, cleaning composition.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A method for cleaning a soiled area of a product, the method comprising:
a) providing a hand-holdable vessel with a dispenser for dispensing a liquid from within the vessel;
b) preparing and placing within the vessel a cleaning composition;
c) placing the vessel with said cleaning composition therein into a microwave oven and heating said composition to a temperature of between about 90 degrees F. and about 220 degrees F.;
d) removing the vessel from the microwave oven;
e) removing the heated cleaning composition from the vessel via the dispenser;
f) applying the heated cleaning composition onto the soiled area to be cleaned; and
g) removing soil from the soiled area.

2. The method of claim 1 wherein the dispenser is a pump and step e) comprises the step of pumping the heated cleaning composition from the vessel via the pump.

3. The method of claim 1 wherein the dispenser is a spout and step e) comprises the step of pouring the heated cleaning composition from the vessel via the spout.

4. The method of claim 1 wherein the dispenser is a spout and step e) comprises the step of dipping a dauber into the heated cleaning composition to soak up the heated cleaning composition and removing the dauber from the vessel.

5. The method of claim 1 wherein step f) comprises the step of daubing the soiled area with a dauber.

6. The method of claim 1 wherein step g) comprises the step of blotting the soiled area with a fibrous towel.

7. The method of claim 6 further comprising the step of vacuuming the soiled area with a vacuum.

8. The method of claim 1 wherein step g) comprises the step of scraping, wiping, scrubbing or sponging the soil from the soiled area.

9. The method of claim 1 further comprising the step of vacuuming the soiled area with a vacuum.

10. The method of claim 9 wherein the soiled area is vacuumed after steps a)-g) with a wet/dry vacuum.
